(19) United States
(12) Patent Application Publication
(10) Pub. No.: US 2025/0042528 A1
(43) Pub. Date: Feb. 6, 2025

(54) A MARINE VESSEL PROPULSION DEVICE

(71) Applicant: Kongsberg Maritime Sweden AB, KRISTINEHAMN (SE)

(72) Inventor: Jan Wall, KRISTINEHAMN (SE)

(73) Assignee: Kongsberg Maritime Sweden AB, KRISTINEHAMN (SE)

(21) Appl. No.: 18/715,482

(22) PCT Filed: Dec. 15, 2022
(86) PCT No.: PCT/EP2022/086228

§ 371 Date: May 31, 2024

(30) Foreign Application Priority Data
Dec. 16, 2021 (SE) 2151536-6

(51) Int. Cl. B63H 23/32; B63H 21/38

(52) U.S. Cl. CPC B63H 23/321; B63H 21/386

(57) ABSTRACT

A propulsion device for the propulsion of a marine vessel includes: a rotatable portion supported by a bearing arrangement with a liquid-lubricated bearing. The rotatable portion has an internal conduit for a liquid for the bearing. The propulsion device transports the liquid for the bearing from a bearing liquid inlet to the internal conduit, and from the internal conduit to a bearing liquid outlet. The bearing liquid outlet is located at a larger radial distance from a rotational axis of the rotatable portion and the rotatable portion has an outlet device with an outlet conduit extending from the internal conduit to the bearing liquid outlet. The outlet device includes a moving part of the bearing, and the outlet conduit extends so as for liquid transported therein to cool the bearing.

### TECHNICAL FIELD

The invention relates to a propulsion device for the propulsion of a marine vessel. The invention also relates to a marine vessel with such a propulsion device.

### BACKGROUND

In large marine propulsion devices, e.g. waterjets for ferries, forces on bearings, e.g. axial bearings transferring the thrust of the devices, can generate large amounts of heat, and therefore effective cooling is important.

U.S. Pat. No. 5,220,231-A describes a propulsor unit for water vehicles. The propulsor unit comprises a bearing assembly with a liquid-lubricated primary trust bearing and a liquid-lubricated secondary trust bearing. It is suggested that to facilitate the circulation of sea water throughout the bearing assembly, an annular support pad includes a plurality of radially disposed impeller bores. It is further suggested that the centrifugal force imparted to the sea water that flows through the impeller bores creates a pressurized flow of water which exits the outer ends of the bores, and flows back along the outer periphery of a support pad of the primary thrust bearing, and from thence between grooves of a bearing ring and on through a central opening present in a runner of the primary thrust bearing.

In a liquid-lubricated bearing, the liquid forms a lubrication medium, and also cools the bearing as it passes through the bearing. There is nevertheless, in view of the large amounts of heat that may be generated in liquid-lubricated bearings of large marine propulsion devices, a desire to provide an improved cooling of such bearings, while retaining an effective manner of transporting the liquid to the bearings.

### SUMMARY

An object of the invention is to provide an improved cooling of a liquid-lubricated bearing of a marine vessel propulsion device, while providing an effective manner of transporting the liquid to the bearing.

The object is reached with a propulsion device according to claim 1. Thus, the invention provides a propulsion device for the propulsion of a marine vessel, the propulsion device comprising
a rotatable portion comprising a thrust generating device adapted to generate a thrust by acting on water supporting the marine vessel,
wherein the rotatable portion is adapted to be connected to a mechanical power provider for rotation of the rotatable portion,
wherein the rotatable portion is supported by a bearing arrangement comprising a liquid-lubricated bearing,
wherein the rotatable portion comprises an internal conduit for a liquid for the bearing,
wherein the propulsion device is arranged to transport the liquid for the bearing from a bearing liquid inlet to the internal conduit, and from the internal conduit to a bearing liquid outlet,
wherein the bearing liquid outlet is, compared to the bearing liquid inlet, located at a larger radial distance from a rotational axis of the rotatable portion
wherein the rotatable portion comprises an outlet device,
wherein the outlet device comprises an outlet conduit extending from the internal conduit to the bearing liquid outlet,
wherein the outlet device comprises a moving part of the bearing, wherein the outlet conduit extends so as for liquid transported therein to cool the bearing.

The liquid-lubricated bearing may be a bearing without rolling elements. The bearing may be a sliding bearing. The sliding bearing may have a lubricating film formed by the liquid. As exemplified below, the bearing may be a pure axial bearing. Thereby, apart from the extension forming the thickness of the lubricating file, the lubricating liquid film extends only in a radial direction, i.e. perpendicularly to the rotational axis of the rotatable portion.

The rotatable portion may be connected to the mechanical power provider directly or via a gearbox. The rotatable portion may comprise a shaft. The shaft may be adapted to carry the thrust generating device. The shaft may be adapted to be connected to the mechanical power provider. The shaft may present at least a portion of the internal conduit for the bearing liquid. Thus, the propulsion device may be arranged to supply the liquid to the bearing via the shaft, for lubricating the bearing. The shaft may be elongated, and the internal conduit may extend along a longitudinal direction of the shaft. The outlet device may be fixed to the shaft.

The rotatable portion may comprise the bearing liquid inlet. The bearing liquid inlet may be arranged to allow the liquid for the bearing to enter the rotatable portion. Where the rotatable portion comprises a shaft, the bearing liquid inlet may be provided in the shaft, or at least fixed in relation to the shaft.

The rotatable portion may comprise the bearing liquid outlet. The outlet device may comprise the bearing liquid outlet. The bearing liquid outlet may be arranged to allow the liquid for the bearing to exit the rotatable portion. The bearing liquid outlet may be provided in the shaft, or at least fixed in relation to the shaft. By the internal conduit, the propulsion device may be arranged to transport the liquid for the bearing through the shaft. Thus, the propulsion device may be arranged to supply the liquid to the bearing via the shaft.

Since the bearing liquid outlet is, compared to the bearing liquid inlet, located at a larger radial distance from the rotational axis of the rotatable portion, the centrifugal force acting on the liquid is larger at the bearing liquid outlet than at the bearing liquid inlet. This difference of the centrifugal forces creates a pumping action forcing liquid from the bearing liquid inlet to the bearing liquid outlet. Thereby, liquid is guided from the bearing liquid inlet to the bearing liquid outlet. Thereby an effective manner of transporting the liquid to the bearing is provided.

The outlet device may allow a relatively large radial distance of the bearing liquid outlet from the rotational axis, so that a relatively large centrifugal force acting on the liquid is provided, allowing an effective pumping effect for the transport of the liquid.

In addition, since the outlet device comprises a moving part of the bearing, and an outlet conduit, for transporting the liquid for the bearing, extends in the outlet device so as for the liquid transported in the outlet conduit to cool the bearing, the liquid provides a cooling effect before it reaches the bearing. This cooling effect comes in addition to the cooling effect that the liquid has as it passes through the bearing. In other words, the liquid provides a cooling effect for the bearing before it reaches the bearing, as well as a cooling effect as it passes through the bearing. For example, the liquid in the outlet conduit may cool the outlet device. Thereby, the outlet device may cool the bearing, since the outlet device comprises a moving part of the bearing. Thereby, the cooling of the bearing is improved.

The outlet conduit may extend in the vicinity of the moving part of the bearing. Preferably, the closest distance between the outlet conduit and a film formed by the liquid between a moving part of the bearing and a non-moving part of the bearing, is less than 40%, preferably less than 30%, preferably less than 20%, preferably less than 15%, preferably less than 10%, of the radial distance of the bearing liquid outlet from the rotational axis of the rotatable portion. Thereby, an effective use of the liquid transport for cooling the bearing may be provided.

Preferably, the liquid is, or comprises, water. The at least a portion of the liquid may be provided from water supporting the marine vessel, e.g. by use of a water pump. Thereby, the marine vessel may be arranged to transport the water from outside of a hull of the marine vessel. For example, the marine vessel may be arranged to transport the water from a waterjet conduit of the marine vessel. The liquid may be filtered before reaching the bearing. In some embodiments, the liquid may be provided from a cooling system of the mechanical power provider. In turn, the liquid in the cooling system may include water provided from water supporting the marine vessel. In some embodiments, one or more additives, e.g. a detergent, may be added to the water. In some embodiments, the liquid may be of another type, such as oil.

Preferably, along a path of the liquid through the propulsion device, the bearing is located downstream of the liquid outlet. Thereby, the liquid may be guided from the bearing liquid outlet to the bearing. Thereby, the risk of cavitation in the bearing, due to a pressure drop over the bearing, is reduced. In other words, the location of the bearing downstream of the liquid outlet allows a relatively high pressure in the bearing, which reduces the risk of cavitation therein. The location of the bearing downstream of the liquid outlet also allows an increased pressure in the transport of the liquid for the bearing. It should be noted that the path of the liquid may change its direction, so that as the liquid is transported along the path, the liquid may, in a certain location along the path, move in a direction which is different from the direction in which the liquid moves in another location along the path.

Preferably, the bearing is radially inwards of the liquid outlet. Thereby, a compact design of the rotational portion and the bearing may be provided.

The bearing may be an axial bearing. Thereby, the liquid may enter the bearing at a first radial boundary of the bearing, and exit the bearing at a second radial boundary of the bearing, the first and second boundaries being at different radial positions. The bearing may be a thrust bearing, i.e. arranged to support transfer a thrust from the thrust generating device to the vessel. It should be noted that alternatively, the bearing may be a radial bearing. The bearing may even be a conical, arranged to support axial as well as radial loads.

Preferably, where the rotatable portion comprises a shaft, the internal conduit extends in a longitudinal direction of the shaft. Thereby, the shaft is effectively utilized for the liquid transport. The shaft conduit may extend centrally in the shaft. Alternatively, a plurality of internal conduits may be provided in the shaft. Thereby, the conduits may be offset from a center of a shaft cross-section.

Preferably, the bearing liquid outlet is located at a periphery of the outlet device. Where the rotatable portion comprises a shaft, the outlet device is preferably fixed to the shaft. Thereby, the larger radial distance of the bearing liquid outlet from the rotational axis may be provided without the need to provide the shaft with a radius sufficient for the radial position of the bearing liquid outlet. However, in some embodiments, the bearing liquid outlet is located radially inside a periphery of the outlet device.

Preferably, the bearing comprises first and second parts arranged to be separated by the liquid, wherein the first part is made in a material which is harder than the second part, wherein the moving part of the bearing is the first part.

The bearing may be a first bearing, wherein the bearing arrangement comprises a second bearing which is also arranged to be lubricated by the liquid from the liquid outlet. The second bearing may be, in relation to the rotation axis of the rotatable portion, located radially inwards of the bearing liquid outlet. I.e. the second bearing may, compared to the bearing liquid outlet, be closer to the rotation axis of the rotatable portion. The second bearing may be located radially inwards of the first bearing. The second bearing may be a radial bearing.

Along a path of the liquid through the propulsion device, the second bearing may be located downstream of the first bearing. Thereby, the liquid may be guided from the first bearing to the second bearing.

Where the rotatable portion comprises a shaft, by the preferred arrangement of the radial second bearing, this bearing may be located at the periphery of the shaft. It may be considered to arrange the radial bearing upstream of the axial bearing. However, this may entail the need to arrange the radial bearing at larger distance from the shaft surface, e.g. at the periphery of a collar which is fixed to the shaft. However, such a collar would add material to the propulsion device. Also, if the radial bearing is located downstream of the axial bearing, the pressure drop over the complete bearing assembly may be controlled by the radial bearing. This is beneficial since the radial bearing will in many applications be the least loaded of the axial and radial bearings. By the radial bearing being located downstream of the axial bearing, the axial bearing may be exposed to a pressure above atmosphere pressure and thereby cavitation may be prevented to a high extent.

It should be noted that in some embodiments, e.g. where the first bearing is conical, the second bearing may be omitted. In some embodiments, the second bearing is, differing from the first bearing, not liquid-lubricated. In such embodiments, the second bearing may be a roller bearing or a ball bearing.

Where the rotatable portion comprises a shaft, the first bearing, and the second bearing where a second bearing is provided, may be arranged to support a first end of the shaft. It should be noted that the bearing arrangement may comprise one or more further bearings. For example, a third bearing may be arranged to support a second end of the shaft. The third bearing may be of any suitable type.

Preferably, the propulsion device comprises a waterjet conduit extending between a waterjet inlet and a waterjet outlet, wherein the thrust generating device is a waterjet impeller in the waterjet conduit. The waterjet inlet and the waterjet outlet may be provided in a hull of a vessel comprising the propulsion device.

Thereby, use of the invention may be made in a waterjet propulsion device. The relatively high rotational speed of such a device may provide a particularly effective transport of the liquid for the bearing by relatively high centrifugal forces acting on the liquid.

Preferably, the bearing is located in a hub of the waterjet impeller.

Preferably, the inlet is provided in an inlet housing arranged to receive the liquid via one or more feeding conduits, wherein a water seal is arranged to prevent water to enter the inlet housing from a space with access to water supporting the marine vessel.

In a waterjet vessel, water supporting the vessel may be guided into a waterjet conduit for the vessel propulsion. As exemplified below, the space with access to water supporting the marine vessel may be provided between a shaft of the propulsion device, on which the inlet is provided, and a shaft tube surrounding the shaft and extending from the inlet housing into the waterjet conduit.

The inlet housing may comprise a movable housing part which is fixed to the propulsion device, and a fixed housing part which is adapted to be fixed to a non-rotatable structure of the vessel. The movable and fixed housing parts may be separated by a further seal. The further seal may seal the housing from air in the interior of the vessel.

The water seal may be arranged as a one-way valve that prevents water to enter the housing.

For example, the water seal may be provided with a lip for this one-way valve function.

Thereby, the water seal may be arranged to allow water to exit the housing. In some embodiments, the water seal may be a labyrinth seal.

For example, depending on the pressure in the feeding conduit, the pressure drop over the water seal, and the pressure in the internal conduit, some of the fed liquid may pass through the water seal. Thereby, it may be secured that liquid is circulated through the inlet housing.

Such a liquid circulation is advantageous to said further seal which may seal the housing from air in the interior of the vessel.

Preferably, the water seal is arranged to that it presents a resistance to any liquid flow from the inlet housing to the space with access to water supporting the marine vessel. Thereby, the water seal has a braking effect that limits the liquid flow from the inlet housing to said space.

Thereby, it is ensured that the inlet housing is not emptied from liquid is case there is a low pressure, or a negative pressure, in said space.

The object is also reached with a marine vessel according to claim 17.

Preferably, where the liquid is, or comprises, water, the marine vessel is arranged to transport the water from outside of a hull of the marine vessel. In some embodiments, the marine vessel comprises a feeding conduit for the water transport, wherein the shaft presents at least a portion of the internal conduit for the water, wherein the marine vessel is arranged to feed the water to the shaft via one or more bearing liquid inlets on the shaft, wherein the bearing liquid inlets are located in an inlet housing, wherein the water is fed to the inlet housing via the feeding conduit. The shaft may extend through the inlet housing, wherein the bearing liquid inlets are located in a cavity of the inlet housing. In some embodiments, the marine vessel is arranged to transport the liquid from a cooling system of the mechanical power provider.

Thereby, the marine vessel may be arranged to transport water in the liquid from outside of the hull of the marine vessel to the cooling system.

### DESCRIPTION OF THE DRAWINGS

Below embodiments of the invention will be described with reference to the drawings in which,

FIG. 1 shows a side view of a ship,

FIG. 2 shows a top view of the ship in FIG. 1,

FIG. 3 shows a view from the back of the ship in FIG. 1,

FIG. 4 shows a water jet propulsion device in the ship in FIG. 1, in a cross-section oriented as indicated by the arrows IV-IV in FIG. 2,

FIG. 5a shows a detail of FIG. 4,

FIG. 5b shows a detail of FIG. 5a,

FIG. 6a shows a detail of FIG. 5a,

FIG. 6b shows a part of the propulsion device in a cross-section oriented as indicated with the arrows VIb-VIb in FIG. 6a,

FIG. 6c shows a detail of FIG. 6a, and

FIG. 7 shows a view similar to the one in FIG. 6a of an alternative embodiment of the invention.

### DETAILED DESCRIPTION

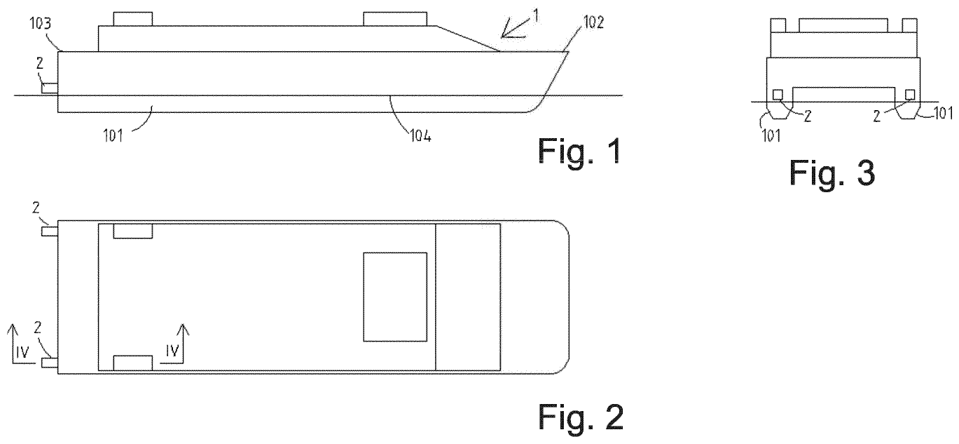

FIG. 1, FIG. 2, and FIG. 3 show a side view, a top view, and a view from the back, respectively, of a marine vessel in the form of a catamaran passenger ship 1. The ship has two hulls 101, a bow 102, a stern 103 and a design waterline 104. It should be noted that the marine vessel could be of many different kinds, e.g. a single hull ship, a pleasure boat, or a jet ski boat.

The vessel is provided with two water jet propulsion devices 2 for the propulsion of the vessel. Each waterjet propulsion device 2 is located at the stern 103. The waterjet propulsion devices are located in a respective of the hulls 101.

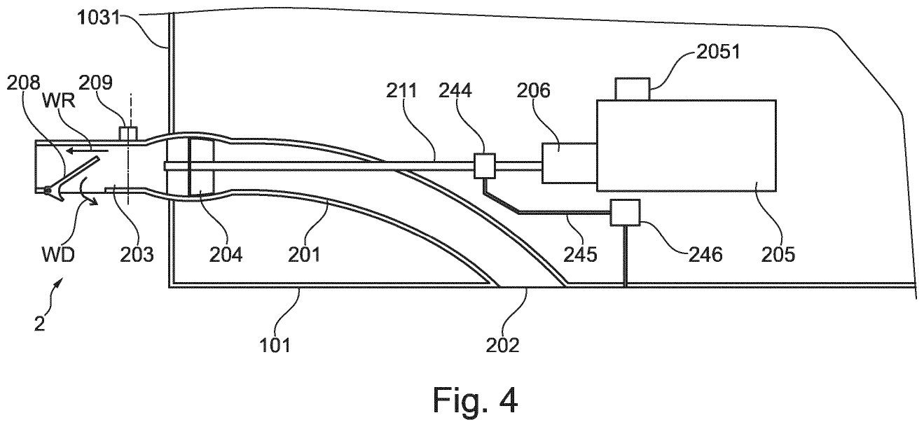

Reference is made also to FIG. 4, showing a schematic cross-section of one of the waterjet propulsion devices of the ship. The waterjet propulsion device comprises a waterjet conduit 201 extending between a waterjet inlet 202 and a waterjet outlet 203. The waterjet inlet is located at a bottom of the hull 101. The waterjet inlet is located beneath the waterline. The waterjet outlet 203 is located above the waterline. The waterjet outlet 203 is located in a transom 1031 of the stern. It should be noted that in some embodiments, the waterjet outlet 203 may be located below the waterline.

The propulsion device comprises a thrust generating device adapted to generate a thrust by acting on water supporting the marine vessel. The thrust generating device is in the form of an impeller 204 is provided in the waterjet conduit 201. The impeller is arranged to pump water from the waterjet inlet 202 to the waterjet outlet 203. Thereby, water supporting the marine vessel can be introduced to the waterjet conduit 201.

The propulsion device comprises a shaft 211 adapted to carry the thrust generating device 204. The thrust generating device is fixed to the shaft. The thrust generating device and the shaft form parts of a rotatable portion of the propulsion device.

The shaft 211 is connected to a mechanical power provider 205 for rotation of the shaft. Thereby, the mechanical power provider can deliver power to the thrust generating device 204 via the shaft. The mechanical power provider 205 is in this example an internal combustion engine. The engine may be a piston engine. Alternatively, the mechanical power provider 205 may be a gas turbine, an electric motor, a hybrid propulsion device, a hydraulic motor, a pneumatic motor, or the like. The mechanical power provider 205 may have any suitable rotational speed range, for example 200-10000 RPM, e.g. 500-2000 RPM.

The waterjet propulsion device comprises a gearbox 206 between the mechanical power provider 205 and the shaft 211. The gearbox may have an input connected to a rotational member, e.g. a crankshaft, of the mechanical power provider 205. The gearbox may reduce the rotational speed of impeller in relation to the rotational speed of the mechanical power provider. The gearbox may have any suitable gear ratio, e.g. 2.7.

The water jet propulsion device comprises a deflector 208 arranged to deflect water flowing out of the waterjet outlet 203. The deflector may be set to a plurality of positions, to control the amount of forward flow, as indicated in FIG. 4 with the arrow WD, and the amount of undeflected flow, as indicated in FIG. 4 with the arrow WR. Thereby, the thrust of the water jet propulsion device may be controlled.

The waterjet propulsion device further comprises a steering device 209, arranged to swing the waterjet outlet 203 around a substantially vertical axis. Thereby, the vessel may be steered while travelling.

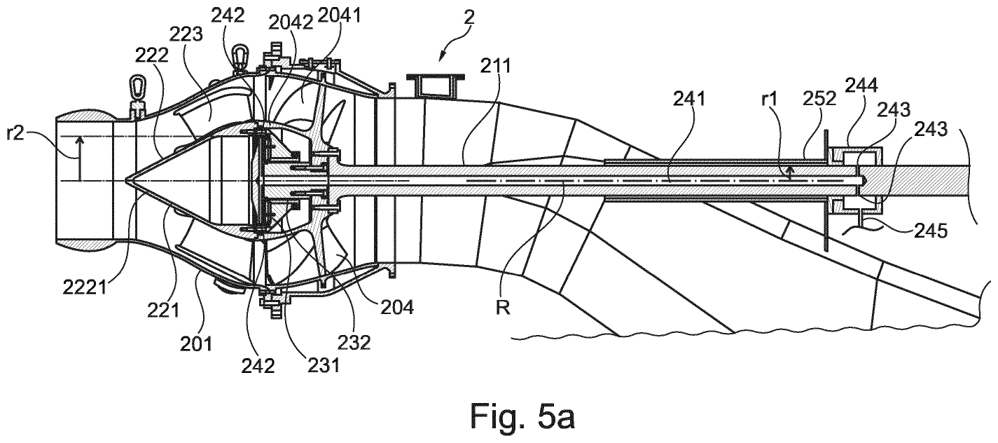

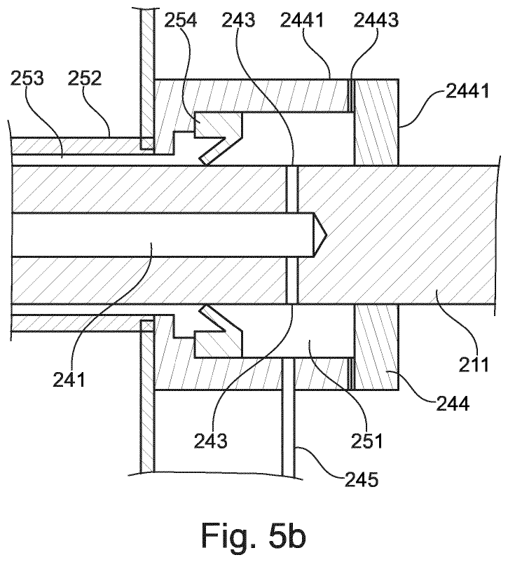

Reference is made to FIG. 5a. The impeller comprises a plurality of blades 2041. A central part 2042 of the impeller 204 forms a part of a hub 221 of the propulsion device. The propulsion device further comprises a stator 222. A central part of the stator forms another part of the hub 221. The central part 2221 of the stator is connected to the waterjet conduit 201 by means of a plurality of vanes 223.

The shaft 211 is supported by a bearing arrangement. The bearing arrangement comprises a bearing in the gearbox 206 (FIG. 4). The bearing arrangement further comprises two bearings in the hub 221 of the propulsion device. The bearings are arranged to be lubricated by a liquid. In this embodiment, the liquid is water. In other embodiments, the bearings may be lubricated by another type of liquid, e.g. oil. In some embodiments, the liquid comprises waster and an additive, such as an anti-freeze agent.

A first of the liquid lubricated bearings is an axial bearing 231. The axial bearing is arranged to support thrust forces of the impeller 204. A second of the liquid lubricated bearings is a radial bearing 232. The liquid lubricated bearings are located in the hub 221.

It should be noted that in some embodiments, only one of the bearings in the hub may be liquid lubricated. Thereby, the other of the bearings in the hub may be a roller bearing or a ball bearing.

The propulsion device is arranged to supply the liquid to the liquid lubricated bearings 231, 232 via the shaft 211. The shaft presents an internal conduit 241, or a part thereof, for the liquid for the liquid lubricated bearings. The internal conduit 241 extends in a longitudinal direction of the shaft. The internal conduit 241 is transversally centered in the shaft. The internal conduit 241 extends along a rotational axis of the shaft 211.

Reference is made also to FIG. 5b. Liquid is fed to the shaft via a plurality of bearing liquid inlets 243 on the shaft 211. For this, the shaft 211 extends through an inlet housing 244. The bearing liquid inlets 243 are located in a cavity 251 of the inlet housing. Liquid is fed to the inlet housing 244 via a feeding conduit 245. The bearing liquid inlets 243 are distributed circumferentially around the rotational axis R of the shaft 211. It should be noted that in some embodiments, there could be only one bearing liquid inlet 243.

The inlet housing 244 comprises a movable housing part 2441 which is fixed to the shaft 211, and a fixed housing part 2442 which is fixed to a non-rotatable structure of the vessel. The movable housing part 2441 and fixed housing part 2442 are separated by a seal 2443.

As can be seen in FIG. 5a, the inlet housing 244 is located externally of the waterjet conduit 201. A shaft tube 252 surrounds the shaft 211 and extends from the inlet housing 244 into the waterjet conduit 201. As can be seen in FIG. 5b, between the shaft and the shaft tube a space 253 is formed. Between the cavity 251 and the space 253 formed by the shaft and the shaft tube a water seal 254 is provided. The water seal 254 is provided with a lip. Thereby, the water seal 254 is arranged as a one-way valve that allows water to exit the cavity 251, but prevents water to enter the cavity 251 from the space 253 formed by the shaft and the shaft tube.

As stated, in this embodiment, the liquid for the bearing is water. As indicated in FIG. 4, the feeding conduit is arranged to transport water from outside of the hull 101. The feeding conduit 245 extends through a feeding unit 246. The feeding unit may comprise a liquid pump and/or a liquid filter. In some embodiments, the water may be fed from the waterjet conduit 201. In some embodiments, an additive can be added to the water after it has been collected from outside of the hull, or from the waterjet conduit. In some embodiments, water or liquid comprising water may be fed from a cooling system of the mechanical power provider 205.

The propulsion device is arranged to allow the bearing lubrication liquid to exit the rotatable portion of the propulsion device through a plurality of bearing liquid outlets 242. As exemplified below, the bearing liquid outlets 242 are distributed circumferentially around the rotational axis R of the shaft 211. It should be noted that in some embodiments, there could be only one bearing liquid outlet 242.

As can be seen in FIG. 5a, the plurality of bearing liquid outlets 242 for the liquid for the liquid lubricated bearings 231, 232 are, compared to the bearing liquid inlets 243, located at a larger radial distance from the rotational axis R of the shaft 211. More generally, the one or more bearing liquid inlets 243 are located at a first radial distance r1 from the rotational axis R of the shaft 211, and the one or more bearing liquid outlets 242 are located at a second radial distance r2 from the rotational axis R of the shaft 211, the second radial distance r2 being larger than the first radial distance r1.

Thereby, the outlet, from the rotatable portion of the propulsion device 2, for the liquid supply for the liquid lubricated bearing(s) 231, 232 takes place, compared to the inlet, to the rotatable portion of the propulsion device 2, for the liquid supply for the liquid lubricated bearing(s) 231, 232 takes place, at a greater radial distance from the rotational axis R of the shaft 211.

Thereby, the centrifugal force acting on the liquid is larger at the bearing liquid outlets 242 than at the bearing liquid inlets 243. This difference of the centrifugal forces creates a pumping action forcing liquid from the bearing liquid inlets 243 to the bearing liquid outlets 242. Thereby, liquid is guided from the bearing liquid inlets 243 to the bearing liquid outlets 242.

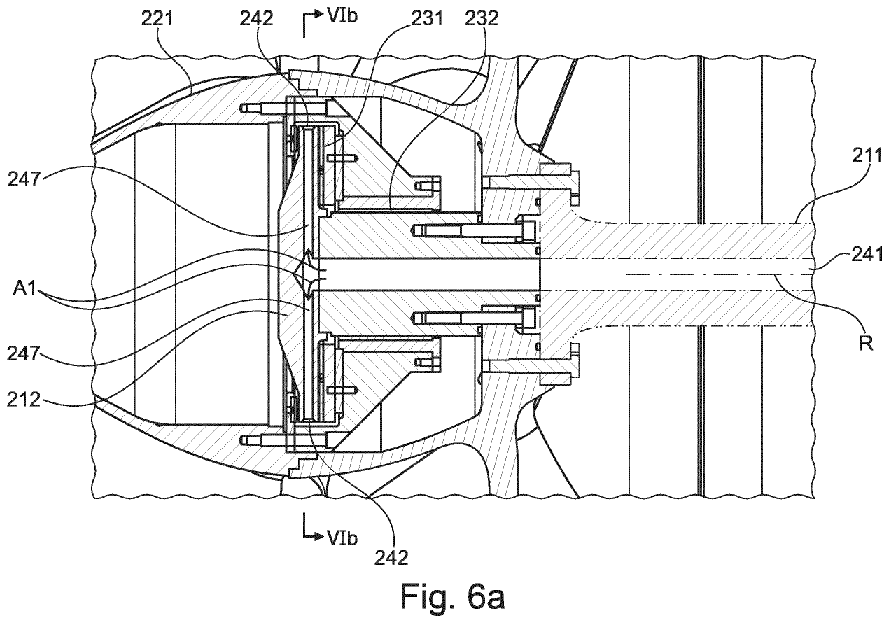

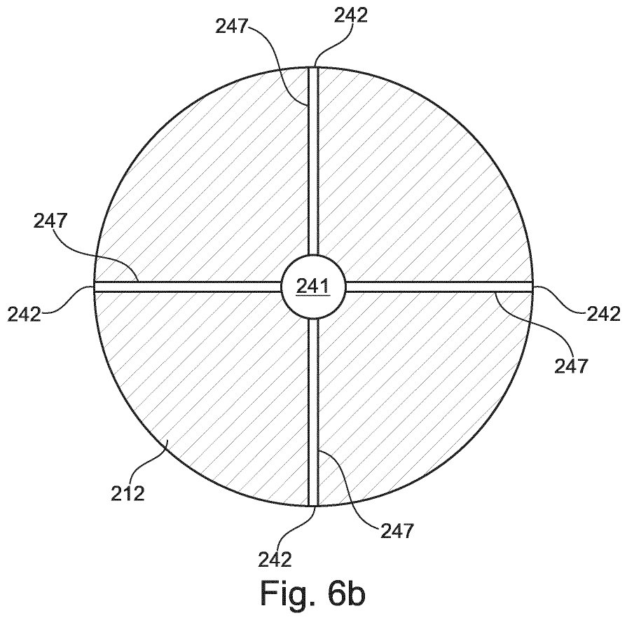

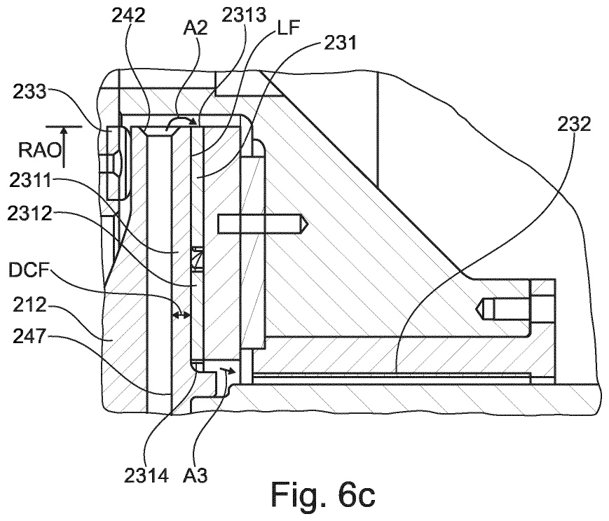

Reference is made also to FIG. 6a. The propulsion device comprises an outlet device 212 which is fixed to the shaft 211. The outlet device 212 is in this example formed as a disc.

Compared to the shaft 211, the outlet device 212 extends radially further from the rotational axis R. The outlet device 212 may be fixed to the shaft 211 in any suitable manner, e.g. by being welded to the shaft, or by being integrated with the shaft.

Reference is made also to FIG. 6b. The bearing liquid outlets 242 are located at a periphery of the outlet device 212. In this example, the internal conduit extends into the outlet device 212.

The outlet device 212 comprises a plurality of outlet conduits 247, each extending from the internal conduit 241 to a respective of the bearing liquid outlets 242. The outlet conduits 247 are distributed circumferentially. The outlet conduits extend radially.

As suggested, the liquid lubricated bearings are located in the hub 221. The liquid is guided, as indicated by the arrows A1, from the internal conduit 241 to the outlet conduits 247.

Reference is made also to FIG. 6c. Along a path of the liquid through the propulsion device, the bearings 231, 232 are located downstream of the liquid outlets 242. The bearings are located radially inwards of the outlets 242. From the outlets 242, the liquid is guided to the axial bearing 231, as exemplified with the arrow A2. The liquid enters the axial bearing between a movable part 2311 of the axial bearing, and a static part 2312 of the axial bearing. The liquid enters the axial bearing at a first radial boundary 2313 of the bearing, and exits the bearing at a second radial boundary 2314 of the bearing. The first radial boundary 2313 is compared to the second radial boundary 2314 located at a larger distance from the rotational axis of the rotatable portion of the propulsion device.

From the axial bearing, the liquid is guided to the radial bearing 232, as exemplified with the arrow A3. The radial bearing 232 is compared to the axial bearing 231 located further from the outlet conduits 247.

The outlet device 212 forms the moving part 2311 of the axial bearing 231. The outlet conduits 247 extend radially along the moving part of the bearing. In this example, the outlet conduits 247 extend in the radial direction past the bearing 231. The outlet conduits 247 extend so that liquid transported therein cools the axial bearing 231. For this, the outlet conduits 247 extend in the vicinity of the axial bearing 231. The outlet conduits 247 extend close enough to the axial bearing 231 for a cooling effect of the axial bearing 231.

Thus, the discharge of the liquid for the bearing, from the rotatable portion of the propulsion device, takes place through the outlet device that comprises the moving part of the bearing. Thereby a cooling of the bearing, e.g. of a friction layer of the movable part of the bearing, is effected by means of the feeding of liquid through the outlet device. Specifically, the outlet device 212, or at least a part thereof, is cooled by the flow of liquid in the outlet conduits 247. In turn, the outlet device cools the bearing 231.

The outlet device 212 may be made of a metal, such as steel, stainless steel, or a copper based material such as brass or bronze. The outlet device 212, or the part thereof forming the outlet conduits 247, may be manufactured from a single piece of material, for example by being casted or forged in one piece. Preferably, the material of the outlet device presents a good thermal conductivity.

The bearing 231 is a sliding bearing with a lubricating film LF formed by the liquid. Preferably the bearing 231 is a pure axial bearing. Thereby, apart from the extension forming the thickness of the lubricating file, the lubricating liquid film extends only in a radial direction, i.e. perpendicularly to the rotational axis of the shaft 211. Therefore, a surface of the static part 2312, facing the movable part 2311, extends substantially only in the radial direction.

The static part 2312 of the bearing is preferably softer than the movable part 2311 of the bearing. The static part of the bearing may be made in rubber or plastic. The static part 2312 may be formed as a ring circumventing the rotational axis of the shaft.

The movable part 2311 may be, as indicated in FIG. 6c, integrated with the part of the outlet device 212 that forms the outlet conduits 247. Alternatively, the movable part 2311 may be formed by a metal deposition on the part of the outlet device 212 that forms the outlet conduits 247. As a further alternative, the movable part 2311 may be formed by a flat ring which is fixed, e.g. directly, to the part of the outlet device 212 that forms the outlet conduits 247.

Preferably, the closest distance DCF between the outlet conduits 247 and lubricating film formed by the liquid, between a moving part 2311 of the bearing 231 and the static part 2312 of the bearing, is less than 40%, preferably less than 30%, preferably less than 20%, preferably less than 15%, preferably less than 10%, in this example approximately 4%, of the radial distance RAO of the bearing liquid outlet 247 from the rotational axis of the rotatable portion.

In this example, the bearing arrangement also comprises a reverse thrust bearing 233 which is also arranged to be lubricated by the liquid from the liquid outlet 242. The reverse thrust bearing 233 is, in relation to the axial bearing 231, located on the opposite side of the outlet device 212. The outlet device 212 comprises a moving part of the reverse thrust bearing 233. The outlet conduit extends 247 so as for liquid transported therein to cool the reverse thrust bearing 233.

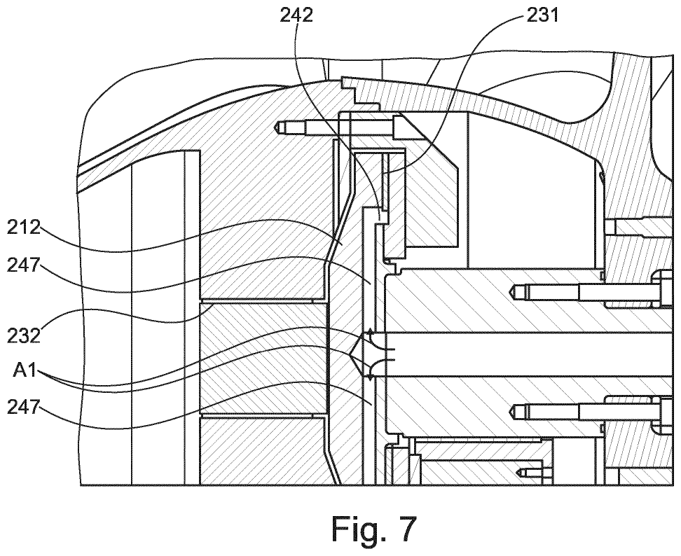

Reference is made to FIG. 7 showing a view similar to the one in FIG. 6a of an alternative embodiment. The embodiment is similar to the one described with reference to FIG. 1-FIG. 6c, but with differences as follows.

The bearing liquid outlets 242 are located inside the periphery of the outlet device 212. The bearing liquid outlets 242 are located radially inside the axial bearing 231. The bearing liquid outlets 242 are located at the inner delimitation of the axial bearing 231. From the outlets 242, the liquid is guided to the axial bearing 231. The liquid enters the axial bearing at a first radial boundary of the bearing, and exits the bearing at a second radial boundary of the bearing. Where the first radial boundary is compared to the second radial boundary located at a smaller distance from the rotational axis of the rotatable portion of the propulsion device.

From the axial bearing, the liquid is guided to the radial bearing 232. The radial bearing 232 is compared to the axial bearing 231 located on the opposite side of the outlet device 212.

The outlet conduits 247 extend so that liquid transported therein cools the axial bearing 231. Thereby a cooling of the bearing is effected by means of the feeding of liquid through the outlet device. Specifically, the outer part of the outlet device 212 is cooled by the flow of liquid in the outlet conduits 247. In turn, the outer part of the outlet device 212 cools the bearing 231.

Alternatives to the embodiments described above are possible. Above, a propulsion device comprising a waterjet impeller has been described. Alternatively, the thrust generating device may be a standard propeller for the propulsion of a marine vessel, such as a ship. As a further alternative, the thrust generating device may be a propeller of a thruster, such as a bow thruster, or a pod thruster.

1-19. (canceled)

20. A propulsion device for the propulsion of a marine vessel, the propulsion device comprising
a rotatable portion comprising a thrust-generating device adapted to generate a thrust by acting on water supporting the marine vessel,
wherein the rotatable portion is adapted to be connected to a mechanical power provider for rotation of the rotatable portion,
wherein the rotatable portion is supported by a bearing arrangement comprising a liquid-lubricated bearing,
wherein the rotatable portion comprises an internal conduit for a liquid for the bearing,
wherein the propulsion device is arranged to transport the liquid for the bearing from a bearing liquid inlet to the internal conduit, and from the internal conduit to a bearing liquid outlet,
wherein the bearing liquid outlet is, compared to the bearing liquid inlet, located at a larger radial distance from a rotational axis of the rotatable portion,
wherein the rotatable portion comprises an outlet device,
wherein the outlet device comprises an outlet conduit extending from the internal conduit to the bearing liquid outlet,
wherein the outlet device comprises a moving part of the bearing,
wherein the bearing is radially inwards of the bearing liquid outlet,
wherein the outlet conduit extends in the radial direction past the bearing so as for liquid transported therein to cool the bearing.

21. A propulsion device according to claim 20, wherein the bearing is a sliding bearing.

22. A propulsion device according to claim 20, wherein the closest distance between the outlet conduit and a film formed by the liquid between the moving part of the bearing and a non-moving part of the bearing, is less than 40%, preferably less than 30%, preferably less than 20%, preferably less than 15%, preferably less than 10%, of the radial distance of the bearing liquid outlet from the rotational axis of the rotatable portion.

23. A propulsion device according to claim 20, wherein the bearing is arranged to be lubricated by a liquid that is, or comprises, water.

24. A propulsion device according to claim 20, wherein bearing is arranged to be lubricated by a liquid, at least a portion of which is provided from water supporting the marine vessel.

25. A propulsion device according to claim 20, wherein, along a path of the liquid through the propulsion device, the bearing is located downstream of the bearing liquid outlet.

26. A propulsion device according to claim 20, wherein the bearing is an axial bearing.

27. A propulsion device according to claim 20, wherein the bearing liquid outlet is located at a periphery of the outlet device.

28. A propulsion device according to claim 20, wherein the bearing comprises first and second parts arranged to be separated by the liquid, wherein the first part is made in a material which is harder than the second part, wherein the moving part of the bearing is the first part.

29. A propulsion device according to claim 20, wherein the bearing is a first bearing, wherein the bearing arrangement comprises a second bearing which is also arranged to be lubricated by the liquid from the liquid outlet.

30. A propulsion device according to claim 29, wherein the second bearing is, in relation to the rotation axis of the rotatable portion, located radially inwards of the bearing liquid outlet.

31. A propulsion device according to claim 29, wherein the second bearing is located radially inwards of the first bearing.

32. A propulsion device according to claim 19, wherein the second bearing is a radial bearing.

33. A propulsion device according to claim 19, wherein, along a path of the liquid through the propulsion device, the second bearing is located downstream of the first bearing.

34. A propulsion device according to claim 20, wherein the propulsion device comprises a waterjet conduit extending between a waterjet inlet and a waterjet outlet, wherein the thrust generating device is a waterjet impeller in the waterjet conduit.

35. A propulsion device according to claim 20, wherein the inlet is provided in an inlet housing arranged to receive the liquid via one or more feeding conduits, wherein a water seal is arranged to prevent water to enter the inlet housing from a space with access to water supporting the marine vessel.

36. A marine vessel comprising a propulsion device according to claim 20.

37. A marine vessel according to claim 36, wherein the bearing is arranged to be lubricated by a liquid that is, or comprises, water, wherein the marine vessel is arranged to transport the water from outside of a hull of the marine vessel.

38. A marine vessel according to claim 37, wherein the marine vessel comprises a feeding conduit for the water transport, wherein the rotatable portion comprises a shaft and the outlet device is fixed to the shaft, wherein the shaft presents at least a portion of the internal conduit for the water, wherein the marine vessel is arranged to feed the water to the shaft via one or more bearing liquid inlets on the shaft, wherein the bearing liquid inlets are located in an inlet housing, wherein the water is fed to the inlet housing via the feeding conduit.
